(19) United States
(12) Patent Application Publication
(10) Pub. No.: US 2018/0157452 A1
(43) Pub. Date: Jun. 7, 2018

(54) DECOMPOSITION OF DYNAMIC GRAPHICAL USER INTERFACES

(71) Applicant: Google Inc., Mountain View, CA (US)

(72) Inventors: Kurtis Nelson, Anaheim, CA (US); Matthew Tait, London (GB)

(21) Appl. No.: 15/372,106

(22) Filed: Dec. 7, 2016

(51) Int. Cl. G06F 3/14; G09G 5/377; G06F 1/16; G04G 9/00

(52) U.S. Cl. CPC G06F 3/1407; G06F 3/1454; G06T 13/80; G06F 1/163; G04G 9/0064; G09G 5/377

(57) ABSTRACT

A system is described that is configured to generate a rendering of a graphical user interface (GUI) for display at a display of a first device and identify a set of dynamic components from the GUI that change during a period of time. The system is further configured to determine respective display information associated with each dynamic component that includes an indication of an image of the corresponding dynamic component; and an indication of a position of the corresponding dynamic component within the GUI during discrete intervals of the period of time. The system is further configured to generate, based on the respective display information, display instructions that configure a second device to display the GUI at a display of the second device, and send, to the second device, the display instructions.

### BACKGROUND

Some computing devices may provide a way for a user to cause the computing device to download and install a graphical user interface (GUI) design from a GUI distribution platform that provides access to GUI designs created by GUI developers. For example, a computerized watch may access a watch face GUI repository from which the computerized watch can download and install instructions for displaying custom watch face GUIs that have been created specifically for rendering and execution by that particular model or type of computerized watch.

Not all computing devices are created equal; some computing devices may have less capability (e.g., less processing power, less memory, less sophisticated display technology, etc.), execute different operating platforms, and/or have less of a user following than other computing devices. Unfortunately, a GUI design that is rich in content and available for download and install by one type of computing device may not be available for download and install, or may not be renderable and executable, by a different, less capable or less popular type of computing device.

### SUMMARY

In general, techniques of this disclosure may enable a computing device to provide a graphical user interface (GUI) that resembles a GUI that was developed for a different computing device. For example, a GUI developer may create display instructions for rendering a watch face GUI that are intended to be executed by a specific model of computerized watch. An example computerized watch that is of a different model or design (e.g., having less processing power, having less memory, having less sophisticated display technology, or by executing a different operating platform than the specific model of computerized watch for which the watch face GUI was designed) may be unable to execute the display instructions and therefore may ultimately be unable to reproduce the watch face GUI as the developer intended. Rather than requiring the developer to manually create a specific version of display instructions for execution by the example computerized watch, the described techniques may provide a way to generate display instructions that enable the example computerized watch to easily reproduce a similar watch face GUI.

To generate display instructions, a rendering of the original watch face GUI is decomposed into multiple image layers of moving and non-moving graphical parts (e.g., “sprite graphics”). The image layers are analyzed to determine specific positions, scales or sizes, opacities, colors, rotations, whether parts are visible or invisible at different times (e.g., a background that is different during daytime than at night), or other characteristic of the moving parts that change with time, distance, location, or some other input. The image layers, along with positions and rotations of the moving parts, are packaged together as display instructions that, when executed, cause the example computerized watch to display a GUI that mimics the appearance of the GUI as the developer intended, without having to natively render or execute the original display instructions that were created by the developer. In this way, the example computerized watch may provide a GUI environment that mimics a watch face GUI that is developed for a different device, even if the example computerized watch relies on different (e.g., less sophisticated) underlying hardware, or executes a different operating platform, than the specific model of computerized watch for which the GUI was designed.

In one example, the disclosure is directed to a method that includes generating, by a computing system, a rendering of a GUI for display at a display of a first wearable device, and identifying, by the computing system, based on the rendering, a set of dynamic components from the GUI that change during a period of time. The method further includes determining, by the computing system, respective display information associated with each dynamic component of the set of dynamic components that includes at least: an indication of an image of the corresponding dynamic component; and an indication of a position of the corresponding dynamic component within the GUI during discrete intervals of the period of time. The method further includes generating, by the computing system, based on the respective display information associated with each dynamic component of the set of dynamic components, display instructions that configure a second wearable device to display the GUI at a display of the second wearable device, and sending, by the computing system, to the second wearable device, the display instructions.

In another example, the disclosure is directed to a computing system that includes at least one processor and a memory. The memory includes executable instructions that, when executed, cause the at least one processor to generate a rendering of a GUI for display at a display of a first wearable device, and identify, based on the rendering, a set of dynamic components from the GUI that change during a period of time. The memory further includes executable instructions that, when executed, cause the at least one processor to determine respective display information associated with each dynamic component of the set of dynamic components that includes at least: an indication of an image of the corresponding dynamic component; and an indication of a position of the corresponding dynamic component within the GUI during discrete intervals of the period of time. The memory further includes executable instructions that, when executed, cause the at least one processor to generate, based on the respective display information associated with each dynamic component of the set of dynamic components, display instructions that configure a second wearable device to display the GUI at a display of the second wearable device, and send, to the second wearable device, the display instructions.

In another example, the disclosure is directed to a second wearable device that includes a display, at least one processor, and a memory. The memory includes executable instructions that, when executed, cause the at least one processor to compose, based on display instructions, a layered bitmap composition of a GUI associated with a first wearable device, wherein the display instructions define: a respective image of each dynamic component of a set of dynamic components from the GUI that change during a period of time in which a rendering of the GUI is displayed by the first computing device, and a respective position of each dynamic component within the GUI during discrete intervals of the period of time. The memory further includes executable instructions that, when executed, cause the at least one processor to output, for display at the display, the layered bitmap composition.

In another example, the disclosure is directed to a computing system that includes means for generating, by a computing system, a rendering of a GUI for display at a display of a first wearable device, and means for identifying, by the computing system, based on the rendering, a set of dynamic components from the GUI that change during a period of time. The computing system further includes means for determining, by the computing system, respective display information associated with each dynamic component of the set of dynamic components that includes at least: an indication of an image of the corresponding dynamic component; and an indication of a position of the corresponding dynamic component within the GUI during discrete intervals of the period of time. The computing system further includes means for generating, by the computing system, based on the respective display information associated with each dynamic component of the set of dynamic components, display instructions that configure a second wearable device to display the GUI at a display of the second wearable device; and means for sending, by the computing system, to the second wearable device, the display instructions.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example system configured to enable a computing device to mimic the display of a graphical user interface that is associated with a different computing device, in accordance with one or more aspects of the present disclosure.

FIG. 2 is a block diagram illustrating an example computing system that is configured to enable a computing device to mimic the display of a graphical user interface that is associated with a different computing device, in accordance with one or more aspects of the present disclosure.

FIGS. 3A through 3D are conceptual diagrams illustrating various static and dynamic components of a graphical user interface, that is associated with a different computing device, as an example computing system decomposes the graphical user interface to enable a computing device to mimic the display of the graphical user interface, in accordance with one or more aspects of the present disclosure.

FIG. 4 is a flowchart illustrating example operations performed by one or more processors of an example computing system that is configured to enable a computing device to mimic the display of a graphical user interface that is associated with a different computing device, in accordance with one or more aspects of the present disclosure.

FIG. 5 is a block diagram illustrating an example computing device that is configured to mimic the display of a graphical user interface that is associated with a different computing device, in accordance with one or more aspects of the present disclosure.

FIG. 6 is a flowchart illustrating example operations performed by one or more processors of an example computing device that is configured to mimic the display of a graphical user interface that is associated with a different computing device, in accordance with one or more aspects of the present disclosure.

### DETAILED DESCRIPTION

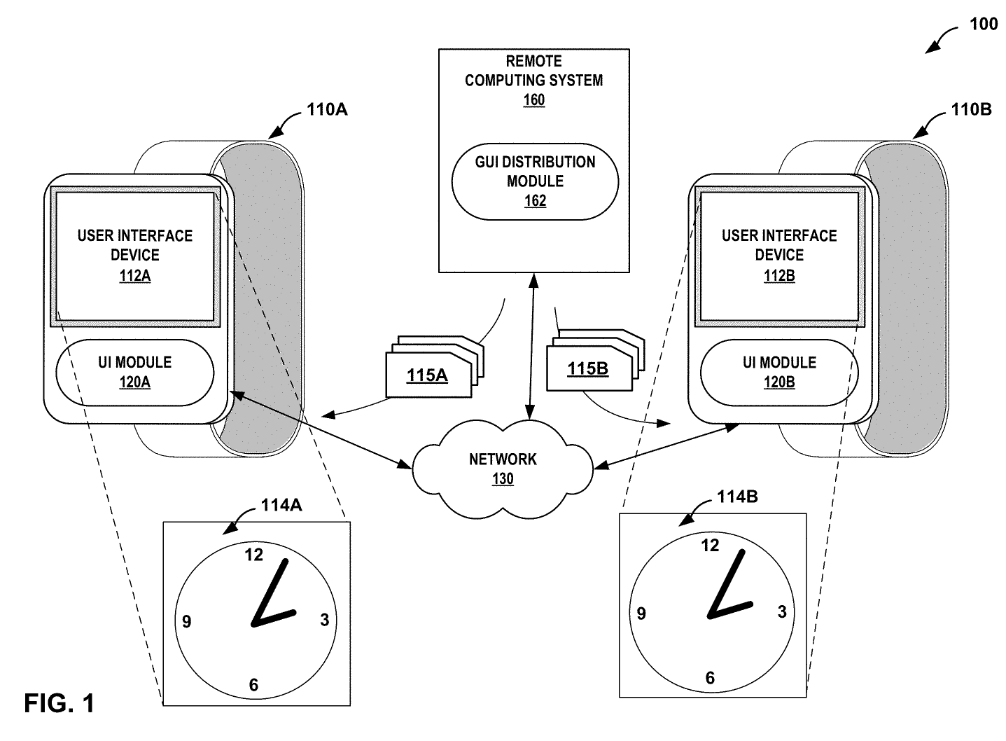

FIG. 1 is a conceptual diagram illustrating an example system configured to enable a computing device to mimic the display of a graphical user interface (GUI) that is associated with a different computing device, in accordance with one or more aspects of the present disclosure. System 100 of FIG. 1 includes remote computing system (RCS) 160 in communication, via network 130, computing device 110A and computing device 110B (collectively “computing devices 110”). Although system 100 is shown as being distributed amongst remote computing system 160 and computing devices 110, in other examples, the features and techniques attributed to remote computing system 160 may be performed internally, by local components of computing devices 110. For example, computing device 110B may include modules or components configured to perform operations associated with content module 164 and decomposition module 166.

Network 130 represents any public or private communications network, for instance, cellular, Wi-Fi, and/or other types of networks, for transmitting data between computing systems, servers, and computing devices. Remote computing system 160 may exchange data (e.g., display instructions), via network 130, with computing devices 110 that enables each of computing devices 110 to provide a respective GUI such as GUI 114A and GUI 114B.

Network 130 may include one or more network hubs, network switches, network routers, or any other network equipment, that are operatively inter-coupled thereby providing for the exchange of information between RCS 160 and computing devices 110. Computing devices 110 and remote computing system 160 may transmit and receive data across network 130 using any suitable communication techniques. Computing devices 110 and remote computing system 160 may each be operatively coupled to network 130 using respective network links. The links coupling computing devices 110 and remote computing system 160 to network 130 may be Ethernet or other types of network connections and such connections may be wireless and/or wired connections.

Remote computing system (RCS) 160 represents any suitable remote computing system that is configured to provide content to computing devices 110 via network 130. In some examples, RCS 160 is a cloud computing system providing services to other devices, such as computing devices 110, through their access the cloud. Examples of RCS 160 include one or more desktop computers, laptop computers, mainframes, servers, cloud computing systems, or any other type of remote computing system that is capable of exchanging information with computing devices, such as computing devices 110, via a network, such as network 130. RCS 160 may be one or more mobile phones, tablet computers, or other mobile or non-mobile computing devices that are configured to communicate with computing devices 110, via a network, such as network 130.

Computing device 110A and computing device 110B are computerized watches that are configured to display, respectively, GUI 114A and GUI 114B, as well as exchange information with remote computing system 160 via network 130. Even though computing devices 110 are computerized watches in the example of FIG. 1, in other examples, computing devices 110 may be any type of mobile or non-mobile computing device that is configured to display a GUI and exchange information via a network. Additional examples of computing devices 110 include mobile phones, tablet computers, laptop computers, desktop computers, servers, mainframes, set-top boxes, televisions, other wearable devices (e.g., computerized eyewear), home automation devices or systems (e.g., intelligent thermostats, computerized smoke or carbon monoxide detectors, home assistant devices), personal digital assistants (PDAs), gaming systems, media players, e-book readers, automobile navigation or infotainment systems, or any other type of mobile, non-mobile, wearable, and non-wearable computing devices configured to display GUIs, such as GUI 114A and GUI 114B, and exchange information via a network, such as network 130.

In the example of FIG. 1, computing device 110A is a “higher-powered” computerized watch, which in the context of this disclosure means that computing device 110A is configured to natively execute display instructions for rendering and displaying a GUI using its own processing capability. In contrast to computing device 110A, computing device 110B is a lower-powered computerized watch, which in the context of this disclosure means that computing device 110B lacks the ability to natively execute display instructions for rendering and displaying certain GUIs (e.g., GUIs that are rich in content) using its own processing capability. Instead, computing device 110B is configured to display certain GUIs by displaying images that have been pre-rendered offline, e.g., by a remote computing device such as RCS 160. For example, as compared to computing device 110A, computing device 110B may have fewer and/or slower processors, less memory, less sophisticated display technology, or otherwise have inferior hardware and/or software and therefore, as is described in greater detail below and with respect to the additional FIGS., computing device 110B relies on external or remote computing devices (e.g., RCS 160) to pre-render images of a GUI in a format that enables computing device 110B to display the GUI without having to perform native rendering.

Computing device 110A includes user interface device (UID) 112A and UI module 120A. Computing device 110B includes UID 112B and UI module 120B. UID 112A and UID 112B (collectively referred to as “UIDs 112”) may function primarily as respective output devices (e.g., display components) for computing devices 110. UIDs 112 may also function as respective input devices for computing devices 110. UIDs 112 may be implemented using various input and output technologies.

UIDs 112 may function as respective input devices using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology, microphone technologies, infrared sensor technologies, or other input device technology for use in receiving user input. For example, UID 112A may include a presence-sensitive display that may receive tactile input from a user of computing device 110A (e.g., by detecting one or more gestures from the user touching or pointing to one or more locations of UID 112A with a finger or a stylus pen).

UIDs 112 may function as respective output devices using one or more display devices, such as liquid crystal displays (LCD), dot matrix displays, light emitting diode (LED) displays, organic light-emitting diode (OLED) displays, e-ink, or similar monochrome or color displays, speaker technologies, haptic feedback technologies, or other output device technology for use in outputting information to a user. For example, UID 112B may include a display that is configured to present GUI 114B.

UID 112A may include different input and/or output technology than the input and/or output technology included in UID 112B. For example, UID 112A may include a higher resolution display than the display included in UID 112B. UID 112A may include more or faster graphics processors or include more or faster memory as compared to the graphics processors and/or memory of UID 112B. In this way UID 112A may provide computing device 110A with the ability to perform native rendering of GUI 114A whereas UID 112B may not have the capabilities required to to natively render GUI 114B.

UI modules 120A and 120B (collectively referred to as “UI modules 120”) may manage user interactions with UID 112A and UID 112B and other components of computing device 110A and computing device 110B, respectively. UI modules 120 may perform operations described using software, hardware, firmware, or a mixture of hardware, software, and firmware residing in and/or executing at a respective one of computing devices 110. Computing devices 110 may execute UI modules 120 with multiple processors or multiple devices. Computing devices 110 may execute UI modules 120 as virtual machines executing on underlying hardware. UI modules 120 may execute as one or more services of an operating system or computing platform. UI modules 120 may execute as one or more executable programs at an application layer of a computing platform.

UI modules 120 may cause UIDs 112 to output GUI 114A and GUI 114B as users of computing devices 110 views output and/or provide input at UIDs 112. UI modules 120 may act as intermediaries between the one or more associated platforms, operating systems, applications, and/or services executing at computing devices 110 and UIDs 112. UI modules and UIDs 112 may receive one or more indications of input (e.g., voice input, gesture input, etc.) from users as the users interact with GUI 114A and GUI 114B. UI modules 120 and UIDs 112 may interpret the inputs detected at UID 112s and may relay information about the inputs detected at UID 112s to one or more platforms, operating systems, applications, and/or services executing at computing devices 110 and/or accessible from computing devices 110 (e.g., executing at RCS 160). In response to the detected inputs, UI module 120s may receive information and instructions (e.g., as display instructions 115A and 115B) from one or more associated platforms, operating systems, applications, and/or services executing at computing devices 110 and/or accessible from computing devices 110 (e.g., executing at RCS 160). UI modules 120 may cause changes to GUI 114A and GUI 114B that reflect the information and instructions received in response to the detected inputs.

Each of GUI 114A and GUI 114B is a watch face GUI that is primarily configured, among other things, to show a time of day. GUI 114A and GUI 114B may appear similar (e.g., having elements with similar colors, shapes, sizes, and other characteristics) however the way in which UI module 120A causes UID 112A to display GUI 114A may be different from the way in which UI module 120B causes UID 112B to display GUI 114B.

For example, UI module 120A may receive display instructions 115A from RCS 160 and perform native rendering techniques to execute display instructions 115A and locally render images for displaying GUI 114A. In contrast, UI module 120B may receive display instructions 115B from RCS 160 which are different from display instructions 115A. Display instructions 115B may include a set of pre-rendered images and associated positioning and rotation information for each image. In this way, rather than having to natively render GUI 114B, UI module 120B causes UID 112B to present GUI 114B by causing UID 112B to display each of the pre-rendered images according to the positioning and rotation information.

RCS 160 includes GUI distribution module 162. GUI distribution module 162 may perform operations described using software, hardware, firmware, or a mixture of hardware, software, and firmware residing in and/or executing at RCS 160. RCS 160 may execute GUI distribution module 162 with multiple processors or multiple devices. RCS 160 may execute GUI distribution module 162 as virtual machines executing on underlying hardware. GUI distribution module 162 may execute as one or more services of an operating system or computing platform. GUI distribution module 162 may execute as one or more executable programs at an application layer of a computing platform.

GUI distribution module 162 is configured to store and provide access to a repository of display instructions associated with different GUI designs that can be downloaded and executed by computing devices 110 for displaying the different GUI designs at UIDs 112. GUI designers or developers may create various GUI designs (e.g., watch faces) intended to be displayed by one or more of computing devices 110. Each of these GUI designs may be stored by GUI distribution module 162 as a set of display instructions. Computing devices 110 may download a set of display instructions from GUI distribution module 162 and execute the display instructions to cause UIDs 112 to present a GUI.

For example, a developer may create display instructions associated with GUI 114A. GUI distribution module 162 may store the display instructions as display instructions 115A. In response to a request for the display instructions from computing device 110, GUI distribution module 162 may cause RCS 160 to send, via network 130 to computing device 110A, a copy of display instructions 115A. UI module 120A may execute display instructions 115A to generate a rendering of GUI 114A and cause UID 112 to display the rendering of GUI 114A.

In addition to providing access to a repository of display instructions associated with different GUI designs, GUI distribution module 162 is further configured to convert the display instructions that are intended to be executed by one type of computing device into a different set of display instruction for later reproduction of the GUI by a different type of computing device. For example, display instructions 115A may be intended to be executed by a computing device, such as computing device 110A, taking full advantage of the hardware and/or software capabilities provided by computing device 110A. Due to a difference in processing capability (e.g., differences in central processing units, graphic processing units, software, etc.), computing device 110A may be able to execute display instructions 115A to natively render and display GUI 114A whereas computing device 110B may be unable to execute display instructions 115A. In order to enable computing device 110B to provide a similar user experience that computing device 110A provides when presenting GUI 114A, GUI distribution module 162 may generate, based on display instructions 115A, display instructions 115B that are executable by computing device 110B for causing computing device 110B to display GUI 114B which resembles GUI 114A.

In operation, to generate display instructions 115B, GUI distribution module 162 may generate a rendering of GUI 114A for display at UID 112A of computing device 110A. In other words, GUI distribution module 162 may execute display instructions 115A to prerender GUI 114A, in a similar way in which computing device 110A would execute display instructions 115A to render GUI 114A, without necessarily causing RCS 160 to display the rendering. Being a watch face GUI, the rendering of GUI 114A may capture up to twelve hours of configuration when GUI 114A is an analog watch face or up to twenty-four hours of configuration when GUI 114A is a digital watch face.

GUI distribution module 162 may identify, based on the rendering, a set of dynamic components from GUI 114A that change during a period of time in which the rendering is displayed (e.g., by computing device 110A). For example, in the case of an analog watch face that covers a twelve-hour period of time, GUI distribution module 162 may isolate one or more static components of GUI 114A (e.g., the background including everything but the watch hands, date complication, or other parts of the watch face that move) by analyzing the rendering for parts of the rendering that remain the same at two opposite times (e.g., 12:00 and 6:30). GUI distribution module 162 may generate a single image (e.g., the background or the static components of GUI 114A that do not change over time) of the parts of the rendering that do not change over time.

The period of time used by GUI distribution module 162 may in some examples correspond to a single day. The period of time may be longer or shorter than a single day. For example, for some dynamic components, running over a longer time may enable GUI distribution module 162 to identify a date or day of week complication by running over a longer period of time (e.g., one month, one week, one year, etc.)

GUI distribution module 162 may isolate one or more dynamic components of GUI 114A by determining the parts of the rendering that do change over time. For instance, GUI distribution module 162 may isolate the part of the rendering that represents the hour hand from GUI 114A as a first dynamic component of the set of dynamic components by determining, based on the rendering, which part of GUI 114A changes position and/or rotation at different hour times within a single twelve-hour period. GUI distribution module 162 may isolate the part of the rendering that represents the minute hand from GUI 114A as a second dynamic component of the set of dynamic components by determining, based on the rendering, which part of GUI 114A changes position and/or rotation at different minute times during a single hour period. GUI distribution module 162 may isolate the part of the rendering that represents the second hand from GUI 114A as a third dynamic component of the set of dynamic components by determining, based on the rendering, which part of GUI 114A changes position and/or rotation at different second times during a single minute period.

GUI distribution module 162 may determine respective display information associated with each dynamic component of the set of dynamic components that includes at least: an indication of an image of the corresponding dynamic component and an indication of a position of the corresponding dynamic component within the GUI during discrete intervals of the period of time. The discrete intervals of the period of time may correspond to a smallest amount of time between changes in the GUI (e.g., one second, one half second, minute, etc.). In other words, GUI distribution module 162 may create an image file for each static component and dynamic component determined from the rendering. The static components may have associated position information indicating a location (e.g., a pixel location) where the image is to be displayed. The dynamic components may not only have associated position information indicating a location (e.g., a pixel location) where the image is to be displayed during a smallest amount of time between changes in the GUI (e.g., each second of a twelve or twenty-four-hour period), but in some examples, the dynamic components may also have associated rotation information indicating an amount of rotation to be applied (if any) to the image during that second.

GUI distribution module 162 may generate, based on the respective display information associated with each dynamic component of the set of dynamic components, display instructions 115B that configure computing device 110B to display GUI 114B at UID 112B. For example, once the dynamic and static components are separated from the rendering of GUI 114A, GUI distribution module 162 may persist the dynamic and static components permanently as display instructions 115B that include instructions for computing device 110B to generate respective images of the components of GUI 114B at the positions, and with the specific amounts of rotation over time, that are required to mimic the movements of the components of GUI 114A over time.

GUI distribution module 162 may send, to computing device 110B, display instructions 115B. For example, GUI distribution module 162 may output display instructions 115B via network 130 to UI module 120B. UI module 120B may execute display instruction 115B to cause UID 112B to display GUI 114B. Executing display instructions 115B may cause UID 112B to display the various images of the static and dynamic components identified from the rendering of GUI 114A using simple image manipulation techniques to cause the images to have positions and/or rotations that change over time. In this way, rather than having to generate a rendering on its own, computing device 110B can execute display instructions 115B to provide a user experience that is similar to that presented by computing device 110A.

Accordingly, the example computerized watch may provide a GUI environment that mimics a watch face GUI that is developed for a different device, even if the example computerized watch relies on different (e.g., less sophisticated) underlying hardware, or executes a different operating platform, than the specific model of computerized watch for which the GUI was designed. Other techniques for displaying a rich watch face GUI on a “dumb watch” or less sophisticated target computing device may require either pre-rendering every possible frame of the rich watch face GUI and persisting it on the target device which may use valuable storage and/or memory. Other techniques for displaying a rich watch face GUI on a less sophisticated target computing device may require a constant connection between the target device and the device that is doing the pre-rendering. With the techniques of this disclosure, an example computing device can execute display instructions that are automatically generated based on a rendering of a GUI which may enable the example computing device to apply simple image rotation to images of components and use hardware rendering techniques to optimize for power and performance. The decomposition of the GUI may only need to happen once, and the result of the computation can be stored in a shared location and re-used by the example computing device and any other client computing device.

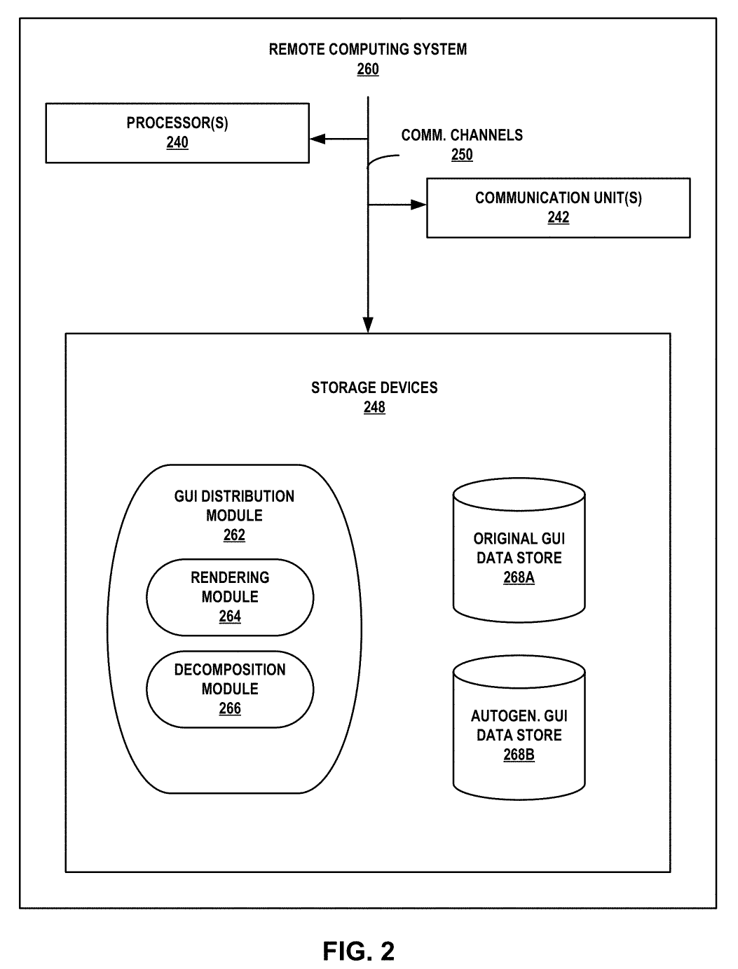

FIG. 2 is a block diagram illustrating an example computing system that is configured to enable a computing device to mimic the display of a graphical user interface that is associated with a different computing device, in accordance with one or more aspects of the present disclosure. Remote computing system (RCS) 260 of FIG. 2 is described below as an example of RCS 160 of FIG. 1. FIG. 2 illustrates only one particular example of RCS 260, and many other examples of RCS 260 may be used in other instances and may include a subset of the components included in RCS 260 or may include additional components not included in FIG. 2.

As shown in the example of FIG. 2, RCS 260 includes one or more processors 240, one or more communication units 242, and one or more storage components 248. Storage components 248 of RCS 260 include GUI distribution module 262, original GUI data store 268A and auto-generated GUI data store 268B. While data stores 268A and 268B are shown as distinct data stores, 268A and 268B may be a single data store that stores both types of information being stored by data stores 268A and 268B. GUI distribution module 262 includes rendering module 264 and decomposition module 266.

Communication channels 250 may interconnect each of the components 240, 242, 248, 262, 264, 266, 268A, and 268B for inter-component communications (physically, communicatively, and/or operatively). In some examples, communication channels 250 may include a system bus, a network connection, an inter-process communication data structure, or any other method for communicating data.

One or more communication units 242 of RCS 260 may communicate with external devices (e.g., computing devices 110 of FIG. 1) via one or more wired and/or wireless networks by transmitting and/or receiving network signals on one or more networks (e.g., network 130 of system 100 of FIG. 1). Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more processors 240 may implement functionality and/or execute instructions associated with RCS 260. Examples of processors 240 include application processors, display controllers, auxiliary processors, one or more sensor hubs, and any other hardware configure to function as a processor, a processing unit, or a processing device. Modules 262, 264, and 266 may be operable by processors 240 to perform various actions, operations, or functions of RCS 260. For example, processors 240 of RCS 260 may retrieve and execute instructions stored by storage components 248 that cause processors 240 to perform the operations performed by modules 262, 264, and 266. The instructions, when executed by processors 240, may cause RCS 260 to store information within storage components 248.

One or more storage components 248 within RCS 260 may store information for processing during operation of RCS 260 (e.g., RCS 260 may store data accessed by modules 262, 264, and 266 during execution at RCS 260). In some examples, storage component 248 is a temporary memory, meaning that a primary purpose of storage component 248 is not long-term storage. Storage components 248 on RCS 260 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 262, 264, and 266 and data stores 268A and 268B. Storage components 248 may include a memory configured to store data or other information associated with modules 262, 264, and 266 and data stores 268A and 268B.

Original GUI data store 268A is a GUI repository that is configured to store display instructions associated with various rich GUI designs. The display instructions stored at data store 268A are intended to be executed by a computing device that is configured to perform native rendering of a GUI. An example of the display instructions stored by data store 268A include display instructions 115A of FIG. 1. For example, the instructions may be created by a developer for execution by a high-powered computerized watch such as computing device 110A. When executed by a computing device, such as computing device 110A, the display instructions may cause that computing device to natively render a particular GUI design locally using a processor of the computing device as part of displaying the GUI at a display of the computing device (e.g., UID 212A).

In contrast to the display instructions stored by original GUI data store 268A, auto-generated GUI data store 268B is configured to store display instructions that have been automatically created by GUI distribution module 262. GUI distribution module 262 may generate, based on the display instructions stored at data store 268A, the display instructions stored at data store 268B for subsequent execution by a computing device, such as computing device 110B, that lacks sufficient processing power or other capabilities necessary to execute the display instructions stored at data store 268A to perform the native rendering of a GUI just prior to its display. An example of the display instructions stored by data store 268B include display instructions 115B of FIG. 1. For example, the instructions may be created by GUI distribution module 262 for execution by a low-powered computerized watch such as computing device 110B.

When executed by a computing device, such as computing device 110B, the display instructions may enable that computing device to perform simple image manipulation techniques to display pre-rendered images of stationary and moving components of the GUI that move or rotate with changes in time. For example, the display instructions for a particular GUI may include display information such as: an indication of an image of a corresponding dynamic component (e.g., an image of a watch hand, complication feature, etc.), an indication of an image of a static component (e.g., a background image, a digit on an analog watch face, etc.), an indication of a position of the corresponding dynamic component within the GUI during discrete intervals of the period of time (e.g., XY pixel coordinate for a particular time period in a particular hour, minute, or day, etc.), an indication of a position of the static component during the period of time, and a rotation of the corresponding dynamic component during the discrete intervals of the period of time (e.g., a degree or amount of rotation for a particular time period in a particular hour, minute, or day, etc.).

The display instruction stored by data stores 268A and 268B may be organized according to name, design characteristic, or other property. The display instructions stored by data stores 268A and 268B may be searchable. GUI distribution module 262 may provide access to the display instructions stored by data stores 268A and 268B as a service for other computing devices to download and install different GUI designs. GUI distribution module 262 may retrieve a set of display instructions stored by data stores 268A and 268B and send the display instructions using communication units 242 to computing devices 110 or other computing devices connected to network 130.

GUI distribution module 262 may perform similar functionality as GUI distribution module 162 of RCS 160 of FIG. 1. For instance, GUI distribution module 262 is configured to store and provide access to the repositories of display instructions stored by data stores 268A and 268B. In addition to providing access to the display instructions stored by data stores 268A and 268B, GUI distribution module 262 is further configured to convert the display instructions stored by data store 268A, that are intended to be executed by one type of computing device, into a different set of display instruction stored by data store 268B, for later reproduction of the GUI by a different type of computing device. GUI distribution module 262 relies on rendering module 264 and decomposition module 264 to convert the display instructions stored at data store 268A to display instructions stored at data store 268B.

Rendering module 264 may generate renderings of GUIs for display at displays of high-powered computing devices, such as computing device 110A. For example, rendering module 264 may execute a model that simulates the operations performed by a processor of a high-powered computing device to execute display instructions stored by data store 268A for rendering and displaying a GUI such as GUI 114A. The rendering of the GUI generated by rendering module 264 may itself be a model that enables GUI distribution module 262 to analyze the features of the GUI for later reproduction by a low-powered computing device, such as computing device 110B. The rendering produced by rendering module 264 may model the features of a GUI as the features change or remain static over time. For example, by specifying a particular time of day as input to the rendering model, the rendering model may provide as output an image output or other indication of the graphical features (e.g., pixel colors and locations) of the GUI at that particular time of day.

Decomposition module 266 may decompose the renderings of GUIs produced by rendering module 264 into individual static and dynamic components and output display instructions that are stored at data store 268B for later execution by a low-powered computing device, such as computing device 110B. For example, decomposition module 266 may provide inputs of two opposite times of day (e.g., 12:00 and 6:30) to a rendering model created by rendering module 264 and receive as output from the rendering model, image outputs of the GUI that provide an indication of the appearance of the GUI when presented at the two opposite times of day. Decomposition module 266 may analyze the image outputs from the rendering model to determine a set of static components of a GUI. The static components may represent the portions of the two image outputs that are the same during the two times. For example, decomposition module 266 may compare the images that are rendered by rendering module 264 and detect any changes by doing a comparison of the pixels. If pixels change from one rendering to another rendering, decomposition module 266 may determine that the change is an indication of a dynamic component.

Decomposition module 266 may isolate and generate an image of the static components and assign positional information to the static components of the GUI that indicates the intended position of the image when the GUI is being output for display. Decomposition module 266 may retain the static images and positional information as a portion of the display instructions stored by data store 268B.

Decomposition module 266 may provide inputs of various other times of day to the rendering model created by rendering module 264 to determine a set of dynamic components of the GUI. Decomposition module 266 may analyze the image outputs from the rendering model to determine the set of dynamic components of the GUI. The dynamic components may represent the portions of the images outputs that change between two or more times of day.

For example, decomposition module 266 may provide the output of an hour counter as an input to the rendering model to determine which portion of the rendering changes with each change in the hour. Decomposition module 266 may store an image of the portion that changes with each change in the hour as an image of the hour hand of the GUI. Decomposition module 266 may provide the output of a minute counter as an input to the rendering model to determine which portion of the rendering changes with each change in the second. Decomposition module 266 may store an image of the portion that changes with each change in the minute as an image of the minute hand of the GUI. Decomposition module 266 may provide the output of an hour counter as an input to the rendering model to determine which portion of the rendering changes with each change in the second. Decomposition module 266 may store an image of the portion that changes with each change in the second as an image of the second hand of the GUI.

While described primarily with respect to identifying dynamic object that change due to changes in time, decomposition module 266 may provide other inputs into the rendering model to determine dynamic components that change with changes in the other inputs. For example, decomposition module 266 may provide the output of a step counter or pedometer as an input to the rendering model to determine which portion of the rendering changes with each change in step count. Decomposition module 266 may provide the output of a day counter, as an input to the rendering model to determine which portion of the rendering changes with each change in day. Decomposition module 266 may run through a whole series of inputs and see if any of them have an effect. Decomposition module 266 may provide the output of a heart monitor, calorie counter, fitness tracker, thermometer, metrological or astronomical sensor, or any other potential source of information for a watch face or complication, as an input to the rendering model to determine which portion of the rendering changes between intervals.

Decomposition module 266 may determine respective display information associated with each dynamic component of the set of dynamic components that includes at least: an indication of an image of the corresponding dynamic component; and an indication of a position of the corresponding dynamic component within the GUI during discrete intervals of the period of time. In some examples, decomposition module 266 may determine an indication of a rotation of the corresponding dynamic component during the discrete intervals of the period of time. For example, decomposition module 266 may assign positional and/or rotational information to the image of the hour hand that indicates the position and/or amount of rotation to apply to the hour hand a various times of day. Similarly, decomposition module 266 may assign positional and/or rotational information to the images of the minute and second hands that indicate the positions and/or amount of rotations to apply to the minute and/or second hands a various times of day.

Decomposition module 266 may generate, based on the respective display information associated with each dynamic component of the set of dynamic components and static component of the set of static components, display instructions that configure a computing device, such as computing device 110B, to display the GUI at a display. For example, decomposition module 266 may package the images and associated positional and rotational information associated with the images that decomposition module 266 decomposed from the rendering model as display instructions. Decomposition module 266 may store the display instructions at data store 268B for later distribution and execution to a computing device, such as computing device 110B.

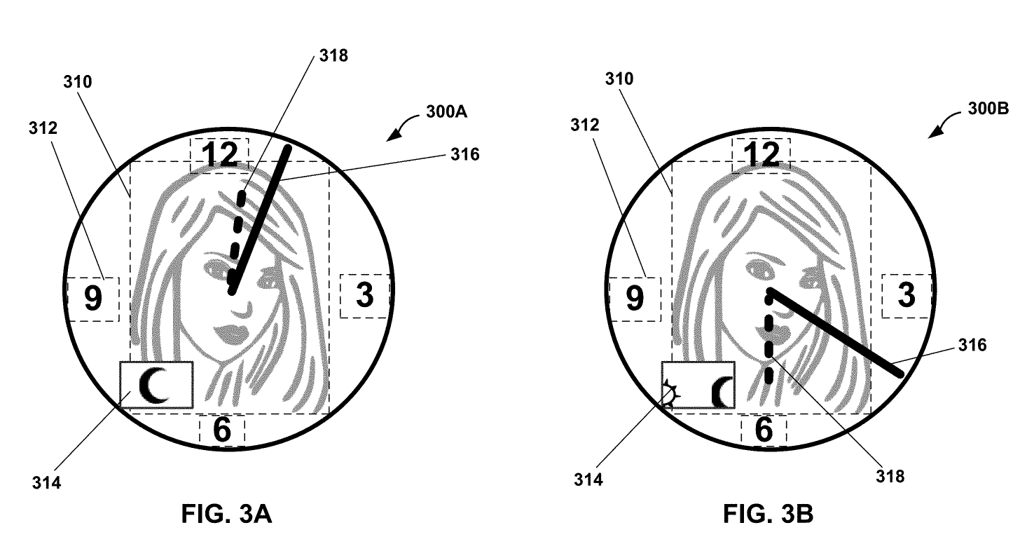

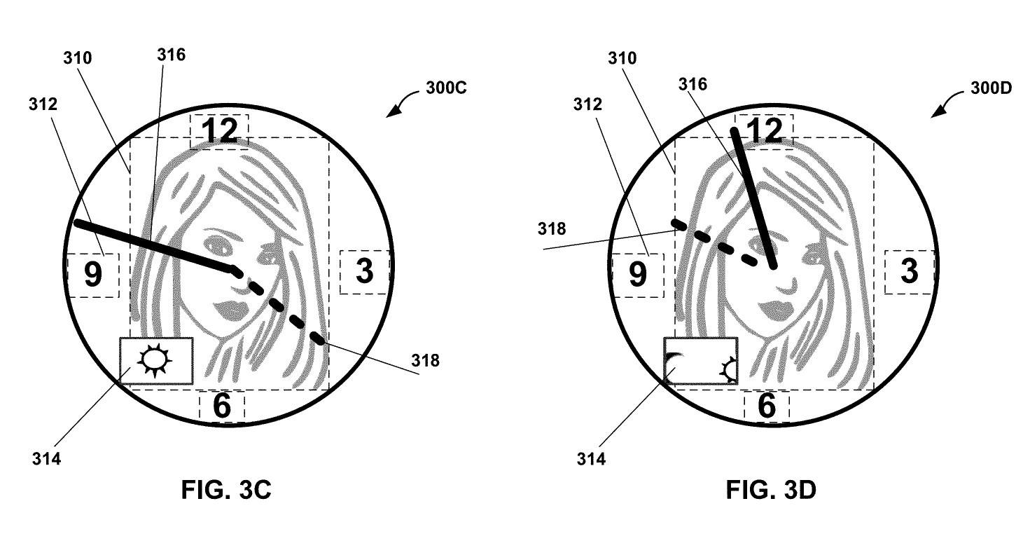

FIGS. 3A through 3D are conceptual diagrams illustrating various static and dynamic components of a graphical user interface, that is associated with a different computing device, as an example computing system decomposes the graphical user interface to enable a computing device to mimic the display of the graphical user interface, in accordance with one or more aspects of the present disclosure. FIGS. 3A through 3D are described in the context of RCS 260 of FIG. 2.

FIGS. 3A through 3D include images 300A-300D which represent example image outputs from rendering module 264 that later get analyzed by decomposition module 266 to produce display instructions stored at data store 268B. For example, FIG. 3A includes image 300A which is an image from a rendering of a watch face GUI at time 12:05AM. FIG. 3B includes image 300B which is an image from the rendering of the watch face GUI at time 5:20AM. FIG. 3C includes image 300C which is an image from the rendering of the watch face GUI at time 4:20PM. FIG. 3D includes image 300D which is an image from the rendering of the watch face GUI at time 10:55PM. Decomposition module 266 may provide an input of 12:05AM to the rendering model that cause the rendering model to output image 300A, decomposition module 266 may provide an input of 5:20AM to the rendering model that cause the rendering model to output image 300B, and so on.

Decomposition module 266 may determine a set of static components of the GUI by determining which portions of images 300A-300D do not change with changes to the time input. For example, decomposition module 266 may determine that clock numerals 312 and background 310 are the set of static components. Decomposition module 266 may generate display instructions for causing a computing device, such as computing device 110B, to display an image of each of clock numerals 312 and background 310 as static images that do not change position or rotation with changes in time.

Decomposition module 266 may determine a set of dynamic components of the GUI by determining which portions of images 300A-300D do change with changes to the time input. Decomposition module 266 may vary the time inputs according to a refresh rate associated with the GUI or display of the intended computing device. In other words, decomposition module 266 may generate a set of image frames of the rendering and identify a particular dynamic component from the set of dynamic components in response to detecting a difference between a portion of a first image from the set of images and a portion of a second image from the set of images.

For instance, the interval may be one minute intervals for a watch face GUI that shows hours and minutes but may be a second for a watch face GUI that shows hours, minutes, and seconds. Decomposition module 266 may determine that hour hand 318 and minute hand 316 are the set of dynamic components that change positions with changes in time. Decomposition module 266 may generate display instructions for causing a computing device, such as computing device 110B, to display an image of hour hand 318 and minute hand 316 as dynamic components that change position and/or rotation with changes in time.

In the example of FIG. 3, decomposition module 266 may further determine complication 314 (e.g., sundial complication) is a dynamic component of the set of dynamic components of the GUI. Decomposition module 266 may generate display instructions for causing a computing device, such as computing device 110B, to display an image of hour hand 318 and minute hand 316 as dynamic components that change position and/or rotation with changes in time.

A particular dynamic component from the set of dynamic components may be an AM/PM indicator, a minute hand of an analog clock face, an hour hand of the analog clock face, or a second hand of the analog clock face. A particular dynamic component from the set of dynamic components may be a minute digit of a digital clock face, an hour digit of the digital clock face, or a second digit of the digital clock face. A particular dynamic component from the set of dynamic components may be a watch complication.

Other examples of complication 314 include email complications, weather complications, calendar event complications, and any other type of complication. Since some dynamic components may change due to parameters other than time, decomposition module 266 may generate display instructions for causing a computing device, such as computing device 110B, to display an image that changes due to changes in other parameters, not just time. For example, other images may change due to changes in location, or in response to receiving updates to information (e.g., notifications). Decomposition module 266 may generate an image of an e-mail complication that has one image when no e-mail notifications are received and may generate a different image of the e-mail complication that has a different image when unread e-mail messages are waiting in an inbox of a user. Decomposition module 266 may generate an image of a calendar complication that has one image when no appointments are coming due and may generate a different image of the calendar complication that has a different image when the current time is nearing an appointment time.

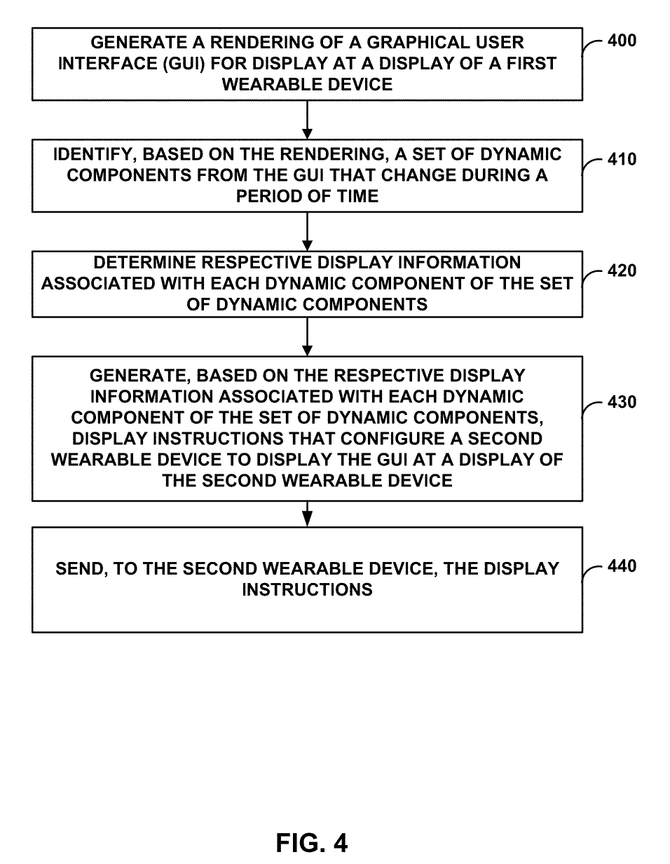

FIG. 4 is a flowchart illustrating example operations performed by one or more processors of an example computing system that is configured to enable a computing device to mimic the display of a graphical user interface that is associated with a different computing device, in accordance with one or more aspects of the present disclosure. Operations 400-440 may be performed by at least one processor of a remote computing system, such as RCS 160 or RCS 260 of FIGS. 1 and 2. FIG. 4 is described in the context of FIG. 2.

In operation, RCS 260 may generate a rendering of a GUI for display at a display of a first wearable computing device (400). For example, rendering module 264 may execute a set of display instructions, such as display instructions 115A, to generate a rendering model of a GUI similar to GUI 114A.

RCS 260 may identify, based on the rendering, a set of dynamic components from the GUI that change during a period of time (410). For example, decomposition module 266 may isolate one or more static components that remain the same regardless of time input to the rendering model. Decomposition module 266 may isolate one or more dynamic components that change based on changes to the time input to the rendering model.

RCS 260 may determine respective display information associated with each dynamic component of the set of dynamic components (420). For example, decomposition module 266 may generate an image of each dynamic and static component and that dynamic and static component's respective position and/or rotation during discrete intervals of the period of time. In other words, decomposition module 266 may create an image file for each static component and an image file for each dynamic component determined from the rendering. The static components may have associated position information indicating a location (e.g., a pixel location) where the image is to be displayed. The dynamic components may not only have associated position information indicating a location (e.g., a pixel location) where the image is to be displayed during each second of a twelve or twenty four hour period, but in some examples, the dynamic components may also have associated rotation information indicating an amount of rotation to be applied (if any) to the image during that second.

RCS 260 may generate, based on the respective display information associated with each dynamic component of the set of dynamic components, display instructions that configure a second wearable device to display the GUI at a display of the second wearable device (440). For example, once decomposition module 266 separates the dynamic and static components from the rendering model, decomposition module 266 may persist the dynamic and static components permanently as display instructions that include instructions for a computing device, such as computing device 110B, to generate respective images of the components at the positions, and with the specific amounts of rotation over time, that are required to mimic the movements of the GUI as depicted by the rendering model.

RCS 260 may send, to the second wearable device, the display instructions (440). For example, GUI distribution module 262 may output the display instructions via network 130 to UI module 120B of computing device 110B. UI module 120B may execute the display instructions to cause UID 112B to display GUI 114B.

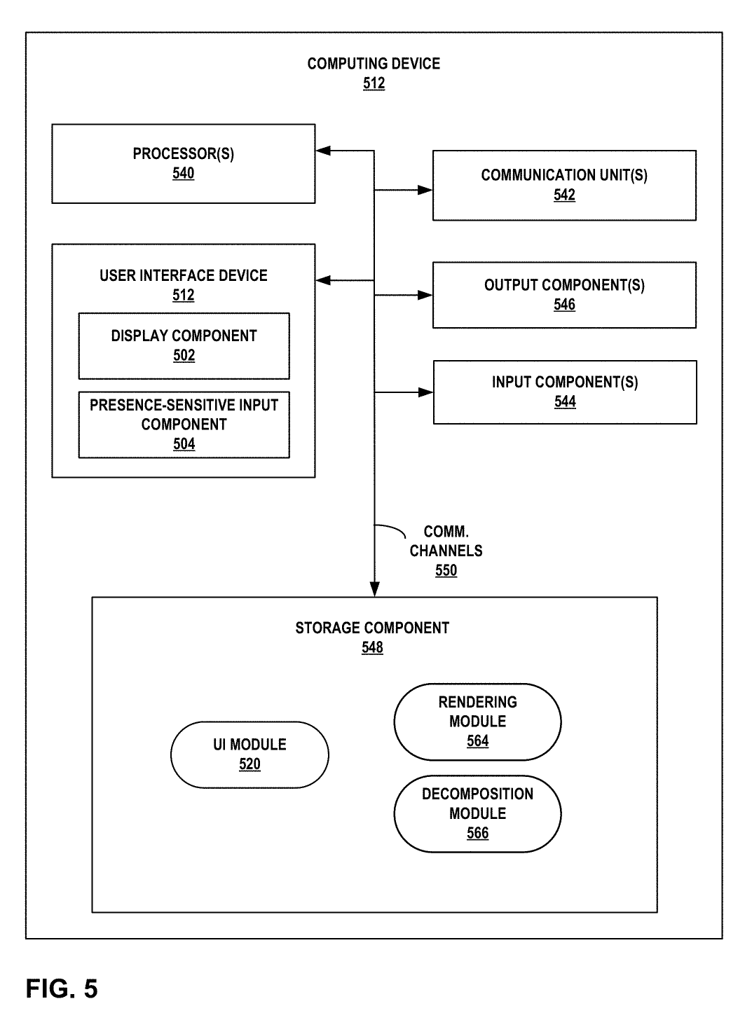

FIG. 5 is a block diagram illustrating an example computing device that is configured to mimic the display of a graphical user interface that is associated with a different computing device, in accordance with one or more aspects of the present disclosure. Computing device 510 of FIG. 5 is described below as an example of computing device 110B of FIG. 1. FIG. 5 illustrates only one particular example of computing device 510, and many other examples of computing device 510 may be used in other instances and may include a subset of the components included in computing device 510 or may include additional components not included in FIG. 5.

As shown in the example of FIG. 5, computing device 510 includes UID 512, one or more processors 540, one or more communication units 542, one or more input components 544, one or more output components 546, and one or more storage components 548. UID 512 includes display component 502 and presence-sensitive input component 504. Storage components 548 of computing device 510 include UI module 520, rendering module 564 and decomposition module 566.

Communication channels 550 may interconnect each of the components 512, 540, 542, 544, 546, and 548 for inter-component communications (physically, communicatively, and/or operatively). In some examples, communication channels 550 may include a system bus, a network connection, an inter-process communication data structure, or any other method for communicating data.

Communication units 542 of computing device 510 are analogous to communication units 242 of RCS 260 of FIG. 2. Communication units 542 may communicate with external devices via one or more wired and/or wireless networks by transmitting and/or receiving network signals on one or more networks.

One or more processors 540 are analogous to processors 240 of RCS 260 of FIG. 2. Processors 540 may implement functionality and/or execute instructions associated with computing device 510. For example, processors 540 of computing device 510 may retrieve and execute instructions stored by storage components 548 that cause processors 540 to perform the operations modules 520, 564, and 566.

One or more input components 544 of computing device 510 may receive input. Examples of input are tactile, audio, and video input. Input components 542 of computing device 510, in one example, includes a presence-sensitive input device (e.g., a touch sensitive screen, a PSD), mouse, keyboard, voice responsive system, camera, microphone or any other type of device for detecting input from a human or machine. In some examples, input components 542 may include one or more sensor components one or more location sensors (GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, step counter sensor.

One or more output components 546 of computing device 510 may generate output. Examples of output are tactile, audio, and video output. Output components 546 of computing device 510, in one example, includes a presence-sensitive display, sound card, video graphics adapter card, speaker, cathode ray tube (CRT) monitor, liquid crystal display (LCD), or any other type of device for generating output to a human or machine.

UID 512 of computing device 510 may be similar to UID 112B of computing device 110B and includes display component 502 and presence-sensitive input component 504. Display component 502 may be a screen at which information is displayed by UID 512 while presence-sensitive input component 504 may detect an object at and/or near display component 502.

While illustrated as an internal component of computing device 510, UID 512 may also represent an external component that shares a data path with computing device 510 for transmitting and/or receiving input and output. For instance, in one example, UID 512 represents a built-in component of computing device 510 located within and physically connected to the external packaging of computing device 510 (e.g., a screen on a mobile phone). In another example, UID 512 represents an external component of computing device 510 located outside and physically separated from the packaging or housing of computing device 510 (e.g., a monitor, a projector, etc. that shares a wired and/or wireless data path with computing device 510).

Computing device 510 includes one or more storage components 548 which are analogous to storage components 248 of RCS 260 of FIG. 2. Storage components 248 may store program instructions and/or information (e.g., data) associated with modules 520, 564, and 566. Storage components 248 may include a memory configured to store data or other information associated with modules 520, 564, and 566.

UI module 520 may include all functionality of UI module 120B of computing device 110B of FIG. 1 and may perform similar operations as UI module 120B for managing a user interface (e.g., user interface 114B) that computing device 510 provides at UID 212. For example, UI module 520 of computing device 510 may receive display instructions from RCS 160 and execute the display instructions to present user interface 114B.

Rendering module 564 and decomposition module 566 are respective examples of modules 264 and 266 from RCS 260 of FIG. 2 that execute locally at computing device 510. In addition to being able to execute display instructions received from a remote computing device, such as RCS 160, computing device 510 is configured to decompose and generate its own set of display instructions for mimicking a GUI meant for display at a different computing device. For example, rendering module 564 and decomposition module 566 may be configured as an emulation module to render the GUI, for instance, if computing device 510 cannot otherwise render and display the GUI sufficiently fast to support real-time interactions with the GUI. Computing device 510 may perform operations 400-430 of FIG. 4 and omit operation 440 (e.g., to avoid sending the display instruction to a second device).

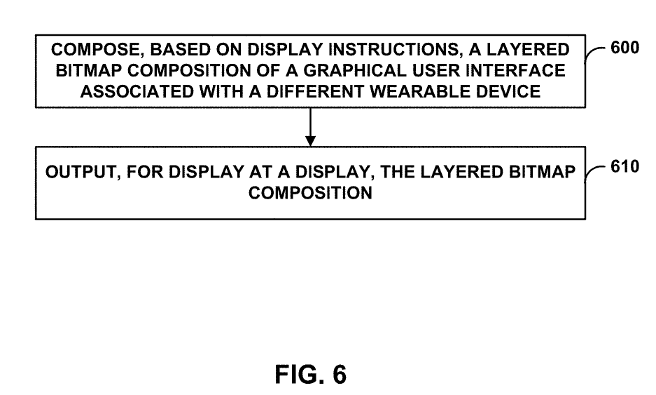

FIG. 6 is a flowchart illustrating example operations performed by one or more processors of an example computing device that is configured to mimic the display of a graphical user interface that is associated with a different computing device, in accordance with one or more aspects of the present disclosure. Operations 600 and 610 may be performed by a processor of a computing device, such as computing device 110B and computing device 510 of FIGS. 1 and 5. FIG. 6 is described in the context of FIG. 5.

In operation, computing device 510 may compose, based on display instructions, a layered bitmap composition of GUI associated with a different wearable device (600). For example, UI module 520 may receive a set of display instructions obtained from RCS 260 as RCS 260 performs operations 400-440 of FIG. 4 or may generate a set of display instructions locally by decomposition module 566 as decomposition module 566 performs operations 400-430 of FIG. 4.

The display instructions may define a respective image of each dynamic component of a set of dynamic components from a GUI that change during a period of time in which a rendering of the GUI is displayed by the different computing device. The display instructions may further define a respective position of each dynamic component within the GUI during discrete intervals of the period of time. The display instructions may further define a respective amount of rotation of each dynamic component within the GUI during the discrete intervals of the period of time, a scaling or size of the corresponding dynamic component during the discrete intervals of the period of time, or an opacity or color of the corresponding dynamic component during the discrete intervals of the period of time, or any other characteristic of a dynamic component that may change between discrete intervals of the period of time. The display instructions may define a respective image of each static component of a set of static components from the GUI that change during the period of time in which the rendering of the GUI is displayed by the different computing device. The display instructions may further define a respective position of each static component within the GUI during discrete intervals of the period of time.

UI module 520 may execute the display instructions to generate layered bitmap composition, with each layer of the bitmap composition corresponding to different static and dynamic components of the GUI. The initial layer (e.g., the bottom layer) may correspond to the static components. The subsequent layers may correspond to the dynamic components.

Computing device 510 may output, for display at a display, the layered bitmap composition (610). For example, UI module 520 may cause UID 512 to present the layered bitmap composition. UI module 520 may manipulate each layer of the composition for each discrete interval of time associated with the composition. For example, UI module 520 may manipulate each dynamic layer according to the respective position and rotation of the component in that layer during each interval of time. For instance, UI module 520 may rotate the layer that includes the hour hand by thirty degrees clockwise each hour interval of time. UI module 520 may rotate the layer that includes the minute hand by six degrees clockwise each minute interval of time. UI module 520 may rotate the layer that includes the second hand by six degrees clockwise each second interval of time. In this way, UI module 520 may cause UID 512 to display individual bitmap images of the layered bitmap composition with a refresh rate based on the discrete intervals of the period of time.

Clause 1. A method comprising: generating, by a computing system, a rendering of a graphical user interface (GUI) for display at a display of a first wearable device; identifying, by the computing system, based on the rendering, a set of dynamic components from the GUI that change during a period of time; determining, by the computing system, respective display information associated with each dynamic component of the set of dynamic components that includes at least: an indication of an image of the corresponding dynamic component; and an indication of a position of the corresponding dynamic component within the GUI during discrete intervals of the period of time; generating, by the computing system, based on the respective display information associated with each dynamic component of the set of dynamic components, display instructions that configure a second wearable device to display the GUI at a display of the second wearable device; and sending, by the computing system, to the second wearable device, the display instructions.

Clause 2. The method of clause 1, further comprising: identifying, by the computing system, based on the rendering, a set of static components from the GUI that do not change during the period of time; and determining, by the computing system, respective display information associated with each static component of the set of static components that includes at least: an indication of an image of the static component; and an indication of a position of the static component during the period of time, wherein the display instructions are further generated based on the respective display information associated with each static component of the set of static components.

Clause 3. The method of any one of clauses 1-2, wherein the respective display information associated with each dynamic component of the set of dynamic components further includes an indication of a rotation of the corresponding dynamic component during the discrete intervals of the period of time, a scaling or size of the corresponding dynamic component during the discrete intervals of the period of time, or an opacity or color of the corresponding dynamic component during the discrete intervals of the period of time.

Clause 4. The method of any one of clauses 1-3, wherein each of the discrete intervals of the period of time corresponds to a frame refresh rate of the display of the second wearable device.

Clause 5. The method of any one of clauses 1-4, wherein the period of time corresponds to at least a single day and each of the discrete intervals of the period of time corresponds to a smallest amount of time between changes in the GUI.

Clause 6. The method of any one of clauses 1-5, wherein identifying the set of dynamic components comprises: generating, by the computing system, a set of image frames of the rendering; and identifying, by the computing devices, a particular dynamic component from the set of dynamic components in response to detecting a different between a portion of a first image from the set of images and a portion of a second image from the set of images.

Clause 7. The method of any one of clauses 1-6, wherein a particular dynamic component from the set of dynamic components comprises an AM/PM indicator, a minute hand of an analog clock face, an hour hand of the analog clock face, or a second hand of the analog clock face.

Clause 8. The method of any one of clauses 1-7, wherein a particular dynamic component from the set of dynamic components comprises an AM/PM indicator, a minute digit of a digital clock face, an hour digit of the digital clock face, or a second digit of the digital clock face.

Clause 9. The method of any one of clauses 1-8, wherein a particular dynamic component from the set of dynamic components comprises a watch complication.

Clause 10. The method of any one of clauses 1-9, wherein the display instructions further configure the second wearable device to display the GUI at the display of the second wearable device by at least composing a layered bitmap composition of the GUI at the display of the second wearable device.

Clause 11. The method of clause 10, wherein the display instructions further configure the second wearable device to compose the layered bitmap image of the GUI at the display of the second wearable device by at least displaying, with a refresh rate based on the discrete intervals of the period of time, individual bitmap images of the layered bitmap composition.

Clause 12. A computing system comprising: at least one processor; and a memory comprising executable instructions that, when executed, cause the at least one processor to: generate a rendering of a graphical user interface (GUI) for display at a display of a first wearable device; identify, based on the rendering, a set of dynamic components from the GUI that change during a period of time; determine respective display information associated with each dynamic component of the set of dynamic components that includes at least: an indication of an image of the corresponding dynamic component; and an indication of a position of the corresponding dynamic component within the GUI during discrete intervals of the period of time; generate, based on the respective display information associated with each dynamic component of the set of dynamic components, display instructions that configure a second wearable device to display the GUI at a display of the second wearable device; and send, to the second wearable device, the display instructions.

Clause 13. The computing system of clause 12, wherein the executable instructions, when executed, further cause the at least one processor to: identify, based on the rendering, a set of static components from the GUI that do not change during the period of time; and determine respective display information associated with each static component of the set of static components that includes at least:

an indication of an image of the static component; and an indication of a position of the static component during the period of time, wherein the display instructions are further generated based on the respective display information associated with each static component of the set of static components.

Clause 14. The computing system of any one of clauses 12-13, wherein the executable instructions, when executed, further cause the at least one processor to: generate a set of image frames of the rendering; and identify a particular dynamic component from the set of dynamic components in response to detecting a different between a portion of a first image from the set of images and a portion of a second image from the set of images.

Clause 15. A second wearable device comprising: a display; at least one processor; and a memory comprising executable instructions that, when executed, cause the at least one processor to: compose, based on display instructions, a layered bitmap composition of a graphical user interface (GUI) associated with a first wearable device, wherein the display instructions define: a respective image of each dynamic component of a set of dynamic components from the GUI that change during a period of time in which a rendering of the GUI is displayed by the first computing device; and a respective position of each dynamic component within the GUI during discrete intervals of the period of time; and output, for display at the display, the layered bitmap composition.

Clause 16. The second wearable device of clause 15, wherein the executable instructions, when executed, cause the at least one processor to output the layered bitmap composition for display by at least displaying, at the display with a refresh rate based on the discrete intervals of the period of time, the layered bitmap composition.

Clause 17. The second wearable device of any one of clauses 15-16, wherein the display instructions further define a rotation of each dynamic component during the discrete intervals of the period of time.

Clause 18. The second wearable device of any one of clauses 15-16, wherein the period of time corresponds to a single day and each of the discrete intervals of the period of time corresponds to a smallest amount of time between changes in the GUI.

Clause 19. The second wearable device of any one of clauses 15-16, wherein a particular dynamic component from the set of dynamic components comprises an AM/PM indicator, a minute hand of an analog clock face, an hour hand of the analog clock face, or a second hand of the analog clock face, a minute digit of a digital clock face, an hour digit of the digital clock face, or a second digit of the digital clock face.

Clause 20. The second wearable device of any one of clauses 15-16, wherein the executable instructions, when executed, cause the at least one processor to receive the display instructions from a mobile phone configured to decompose the display instructions from a rendering of the GUI for display at a display of the first wearable device.

Clause 21. A computer-readable storage medium comprising instructions that when executed cause at least one processor of a computing system to perform the method of any one of clauses 1-11.

Clause 22. A system comprising means for performing the method of any one of clauses 1-11.

Clause 23. The computing system of clause 12 further comprising means for performing the method of any one of clauses 1-11.

Clause 24. A computer-readable storage medium comprising instructions that when executed cause at least one processor of a wearable computing device to perform the method of any one of clauses 1-11.

Clause 25. The second computing device of clause 15 further comprising means for performing the method of any one of clauses 1-11.

In one or more examples, the functions described may be implemented in hardware, software, firmware, or any combination thereof If implemented in software, the functions may be stored on or transmitted over, as one or more instructions or code, a computer-readable medium and executed by a hardware-based processing unit. Computer-readable medium may include computer-readable storage media or mediums, which corresponds to a tangible medium such as data storage media, or communication media including any medium that facilitates transfer of a computer program from one place to another, e.g., according to a communication protocol. In this manner, computer-readable medium generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various embodiments have been described. These and other embodiments are within the scope of the following claims.

What is claimed is:

1. A method comprising:
generating, by a computing system, a rendering of a graphical user interface (GUI) for display at a display of a first wearable device;
identifying, by the computing system, based on the rendering, a set of dynamic components from the GUI that change during a period of time;
determining, by the computing system, respective display information associated with each dynamic component of the set of dynamic components that includes at least:
an indication of an image of the corresponding dynamic component; and
an indication of a position of the corresponding dynamic component within the GUI during discrete intervals of the period of time;
generating, by the computing system, based on the respective display information associated with each dynamic component of the set of dynamic components, display instructions that configure a second wearable device to display the GUI at a display of the second wearable device; and
sending, by the computing system, to the second wearable device, the display instructions.

2. The method of claim 1, further comprising:
identifying, by the computing system, based on the rendering, a set of static components from the GUI that do not change during the period of time; and
determining, by the computing system, respective display information associated with each static component of the set of static components that includes at least:
an indication of an image of the static component; and
an indication of a position of the static component during the period of time,
wherein the display instructions are further generated based on the respective display information associated with each static component of the set of static components.

3. The method of claim 1, wherein the respective display information associated with each dynamic component of the set of dynamic components further includes an indication of a rotation of the corresponding dynamic component during the discrete intervals of the period of time, a scaling or size of the corresponding dynamic component during the discrete intervals of the period of time, or an opacity or color of the corresponding dynamic component during the discrete intervals of the period of time.

4. The method of claim 1, wherein each of the discrete intervals of the period of time corresponds to a frame refresh rate of the display of the second wearable device.

5. The method of claim 1, wherein the period of time corresponds to at least a single day and each of the discrete intervals of the period of time corresponds to a smallest amount of time between changes in the GUI.

6. The method of claim 1, wherein identifying the set of dynamic components comprises:
generating, by the computing system, a set of image frames of the rendering; and
identifying, by the computing devices, a particular dynamic component from the set of dynamic components in response to detecting a difference between a portion of a first image from the set of images and a portion of a second image from the set of images.

7. The method of claim 1, wherein a particular dynamic component from the set of dynamic components comprises an AM/PM indicator, a minute hand of an analog clock face, an hour hand of the analog clock face, or a second hand of the analog clock face.

8. The method of claim 1, wherein a particular dynamic component from the set of dynamic components comprises a minute digit of a digital clock face, an AM/PM indicator, an hour digit of the digital clock face, or a second digit of the digital clock face.

9. The method of claim 1, wherein a particular dynamic component from the set of dynamic components comprises a watch complication.

10. The method of claim 1, wherein the display instructions further configure the second wearable device to display the GUI at the display of the second wearable device by at least composing a layered bitmap composition of the GUI at the display of the second wearable device.

11. The method of claim 10, wherein the display instructions further configure the second wearable device to compose the layered bitmap image of the GUI at the display of the second wearable device by at least displaying, with a refresh rate based on the discrete intervals of the period of time, individual bitmap images of the layered bitmap composition.

12. A computing system comprising:
at least one processor; and
a memory comprising executable instructions that, when executed, cause the at least one processor to:
generate a rendering of a graphical user interface (GUI) for display at a display of a first wearable device;
identify, based on the rendering, a set of dynamic components from the GUI that change during a period of time;
determine respective display information associated with each dynamic component of the set of dynamic components that includes at least:
an indication of an image of the corresponding dynamic component; and
an indication of a position of the corresponding dynamic component within the GUI during discrete intervals of the period of time;
generate, based on the respective display information associated with each dynamic component of the set of dynamic components, display instructions that configure a second wearable device to display the GUI at a display of the second wearable device; and
send, to the second wearable device, the display instructions.

13. The computing system of claim 12, wherein the executable instructions, when executed, further cause the at least one processor to:
identify, based on the rendering, a set of static components from the GUI that do not change during the period of time; and
determine respective display information associated with each static component of the set of static components that includes at least:
an indication of an image of the static component; and
an indication of a position of the static component during the period of time,
wherein the display instructions are further generated based on the respective display information associated with each static component of the set of static components.

14. The computing system of claim 12, wherein the executable instructions, when executed, further cause the at least one processor to:
generate a set of image frames of the rendering; and
identify a particular dynamic component from the set of dynamic components in response to detecting a different between a portion of a first image from the set of images and a portion of a second image from the set of images.

15. A second wearable device comprising:
a display;
at least one processor; and
a memory comprising executable instructions that, when executed, cause the at least one processor to:
generate, based on display instructions, a layered bitmap composition of a graphical user interface (GUI) associated with a first wearable device, wherein the display instructions define:
a respective image of each dynamic component of a set of dynamic components from the GUI that change during a period of time in which a rendering of the GUI is displayed by the first computing device; and
a respective position of each dynamic component within the GUI during discrete intervals of the period of time; and
output, for display at the display, the layered bitmap composition.

16. The second wearable device of claim 15, wherein the executable instructions, when executed, cause the at least one processor to output the layered bitmap composition for display by at least displaying, at the display with a refresh rate based on the discrete intervals of the period of time, the layered bitmap composition.

17. The second wearable device of claim 15, wherein the display instructions further define a rotation of each dynamic component during the discrete intervals of the period of time.

18. The second wearable device of claim 15, wherein the period of time corresponds to a single day and each of the discrete intervals of the period of time corresponds to a smallest amount of time between changes in the GUI.

19. The second wearable device of claim 15, wherein a particular dynamic component from the set of dynamic components comprises an AM/PM indicator, a minute hand of an analog clock face, an hour hand of the analog clock face, or a second hand of the analog clock face, a minute digit of a digital clock face, an hour digit of the digital clock face, or a second digit of the digital clock face.

20. The second wearable device of claim 15, wherein the executable instructions, when executed, cause the at least one processor to receive the display instructions from a mobile phone that is configured to decompose the display instructions from a rendering of the GUI for display at a display of the first wearable device.
